(19) United States
(12) Patent Application Publication
(10) Pub. No.: US 2011/0105169 A1
(43) Pub. Date: May 5, 2011

(54) Wireless/Laser Registration Method and System

(76) Inventor: Julian Prabhu, Huntington Beach, CA (US)

(21) Appl. No.: 12/610,321

(22) Filed: Nov. 1, 2009

(51) Int. Cl. H04W 60/00

(52) U.S. Cl. 455/509

(57) ABSTRACT

Registration is required for all vehicles, equipment, appliances, conferences, events, etc. The proposed concept is to provide each unit described as a vehicle, equipment, appliance, vessel, train, lifeguard station etc., that requires registration, with a wireless device that can display pertinent information (technical and operational data) and personal details such as, registration month and year, car vehicle identification number, license plate number, owners name and address etc. This device operates similar to a wireless mobile phone or an onboard vehicle global positioning system (GPS) and can be managed from a central location. Such a system can also be used for multiple other events such as—vehicle or trade shows, outdoor events, conferences, animal tags etc.

### BRIEF SUMMARY OF INVENTION

All vehicles, equipment, vessels, containers, events etc., hereafter identified as units, require registration. Vehicles are normally registered with the government by mail and in recent years online, over the internet, by corporations, individuals etc. The government mails out the registration material to the individual or the entity who in turn returns the completed registration material and payment to the government, which then issues the registration stickers by mail to the individual or entity to be placed on the vehicle or vehicle license plate. The stickers show the year and month of expiration and may be color coded. This process by the government requires huge amounts of resources such as time, people, paper, mailing, delivery, postage, record keeping etc.

The proposed concept adopts a more green approach by utilizing the existing GPS or wireless technology that reduces resources such as delivery, transportation, postage, paper record keeping, envelopes, time and labor etc. involved in the process. All of these resources could be converted into revenue which could run into the millions of dollars in savings for the government or entities by the adoption of this proposed concept.

This concept provides one or more wireless/laser devices that displays a view screen that once activated displays the vehicle registration month, year and other pertinent details such as vehicle identification number, license plate number, vehicle make and model, vehicle owner etc.

This concept can also be used for registering individuals and animals at other events such as, concerts, conferences, vehicle shows etc.

### FIELD OF INVENTION

This invention is related to the wireless industry, in particular, the transportation industry

### BACKGROUND

Every transportation vehicle (defined as a unit) needs to be registered with the government. Currently all registration is done by mail and manually. This proposed invention requires a wireless device be installed in every unit which will allow registration and transfer of pertinent technical and operational data to be accomplished electronically by the government.

### DETAILED DESCRIPTION

The proposed concept, a mobile wireless/laser device, similar to a mobile wireless phone, will be assigned a number that is linked to the vehicle license plate number and the vehicle identification number and can be made up of letters or numerals or a combination thereof. The wireless/laser device can also be assigned the unit license plate number or the unit identification number. In addition, the vehicle will be assigned an RFID (Radio Frequency Identification Device) tag which bears a number and this tag will be linked to the wireless device. The wireless/laser device can be registered to an individual or an entity, similar to a mobile wireless phone and can be placed inside the unit or on the unit license plate or installed with the ignition system. The wireless device will contain registration information of only that unit in which it is installed and all units in which the device is installed will be linked to a central network, “An eye in the sky”, via satellite (Global Positioning System), as shown in FIG. 1. The central network system can be operated only by authorized individuals, law enforcement or government agencies, from a central or satellite locations. This concept has many advantages for government agencies such as Department of Motor Vehicles (DMV), Law Enforcement, Military, Navy, DOD, Homeland Security etc., advantages such as, monitoring traffic patterns, accidents, drunk and speeding drivers, registration violators, stolen vehicles etc., and thereby preventing many incidents from happening before they actually happen. This could potentially save thousands of lives and infrastructure costs worldwide. This concept can also be applied to vehicles such as government vehicles, construction equipment, trains, airplanes, commercial and passenger ships, shipping containers, boats, home appliances, lifeguard stations etc.

To one skilled in this field of technology, many embodiments of this concept may be designed. In a preferred embodiment, this wireless device is placed in a secure location inside the vehicle or on a vehicle license plate or installed to the ignition. At any time, a government agency such as the DMV, can verify the current status of the vehicle registration whether the unit is in motion, paralyzed, parked or destroyed, by typing into the central database network, the unit license plate number or wireless device number or unit identification number. All of these numbers will be linked to the unit in question. The results will show whether the unit is registered or not and the DMV can take appropriate action to notify the individual or entity by email or telephone or regular mail or even the wireless device itself can be “beeped” to get the attention of the unit driver or the device can be programmed to display a bold “red or green” dot as shown in FIG. 4 or the audio/video GPS vehicle onboard display as shown in FIG. 5. The payment methods are shown in FIG. 6.

In a second embodiment as shown in FIG. 7, the red dot will alert law enforcement agents of a possible registration violation, who could then type in the unit license plate number into their onboard computer or use an RFID gun to read the RFID tag on the license plate. The agent's onboard computer will have access to the central database network and this will provide the agents the information about the unit's registration status and they could then take appropriate action necessary.

In a third embodiment, this device when installed in a shipping container can give the appropriate law enforcement agency the exact location of the container and its contents by simply typing in the containers wireless device registration number into their computer which has access to the central database network.

In a fourth embodiment, this device can be installed in each train engine, and cars of a passenger or cargo train. The appropriate train owner or agency can type into their computer which has access to the central database network, the wireless device number assigned to each engine or car or train and can monitor its location and contents and alert the train conductor of any issues or emergencies that may occur such as a collision with an oncoming train on the same track or a vehicle, animal, pedestrian crossing the tracks.

### BRIEF DESCRIPTION OF DRAWINGS

FIG. 1 shows a wireless device embedded or installed anywhere in or on a unit and receives its commands from the central registration database network system via the satellite/Global Positioning System (GPS).

FIG. 2 shows a wireless device embedded or installed anywhere in or on a unit and receives its commands from the central registration database network system via the satellite/GPS network system and a cell tower (CT)/Hotspot (HTS).

FIG. 3 shows an email/text message reminder from the central registration database network system via the satellite/GPS network system to the unit onboard GPS or owner cell phone, blackberry, and desk top or similar gadget.

FIG. 4 shows a wireless device with a display screen that displays pertinent information such as registration month, year, and red light showing registration inactive or green light showing registration active. The device is also capable of recording and displaying other data such as unit speed, unit location, fuel consumption, mileage, unit ID, owners name, unit registration number, etc. The unit is powered by a battery or alternating current or solar power.

FIG. 5 shows a units onboard Global Positioning System (GPS) audio/video display screen that displays a red or green light that indicates whether the registration is active or inactive. It also announces a message such as, “The registration is due on or before a certain date” or “Registration expires on a certain date”

FIG. 6 shows a units onboard GPS screen that announces or displays a message or messages such as “Do you want to pay bills, unit registration, toll fees, national park fees or parking fees etc.” It also displays or announces Yes (Y) or No (N). If “Y”, it announces or displays, do you want to pay by credit card etc. If “Y”, it will ask for further information to complete the transaction such as credit card information, name etc. The unit is basically an onboard wireless payment system where the owner punches in the data or swipes a card or some similar system.

FIG. 7 shows the registration status of multiple units in motion that can be viewed from the computer console of any law enforcement agency or office located anywhere

FIG. 8 shows a wireless device mounted on any toll plaza or any desired location and connected to the central registration database network system via the satellite/GPS network system. The device monitors and records all data for any units entering or exiting the parking structure/s or any desired parking locations such as beaches, shopping malls, street parking, government offices, airports, etc.

FIG. 9 shows an emergency notification system wireless device mounted or embedded on each Life guard station, Ambulance, Law enforcement agency vehicle, Fire truck, Traffic lights etc., anywhere and connected to the central registration database network system via the satellite/GPS network system. The emergency notification system will be voice activated and will have a red button alarm system that will be activated by the user to alert the appropriate authorities for help.

FIG. 10 shows a wireless device in the form of a patch mounted on an individuals clothing or person, on any unit (such as a vehicle, etc.), on any object (such as a basketball, etc.) and connected to the central registration database network system via the satellite/GPS network system.

What is claimed is:

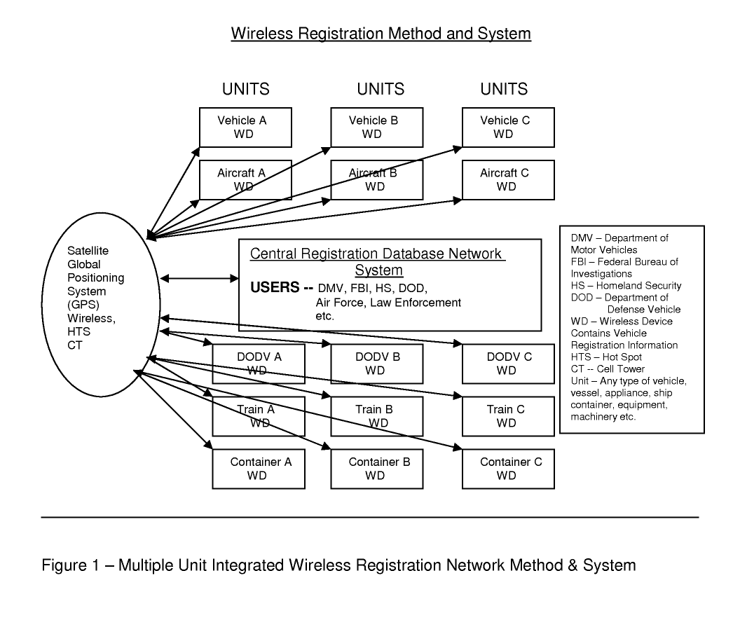

1. A multiple unit integrated wireless registration network method & system as shown in FIG. 1. A unit being defined as any vehicle, vessel, aircraft, train, container, appliance, lifeguard station etc., that requires registration

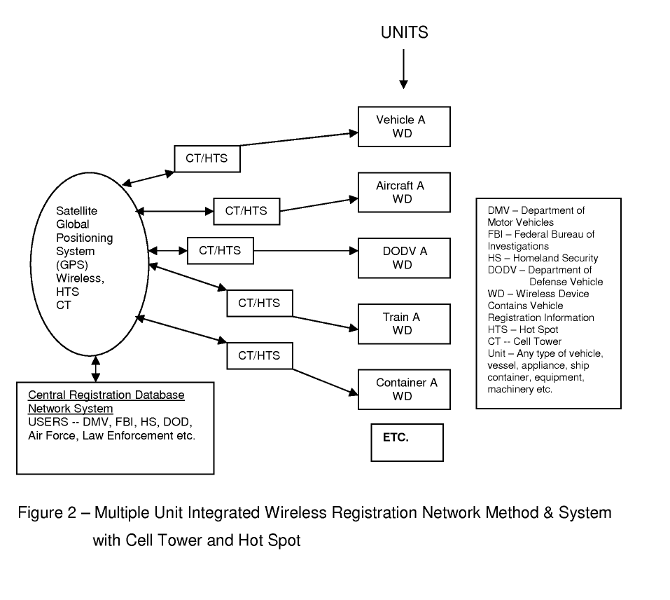

2. With ref. to claim 1, A multiple unit integrated wireless registration network method & system with cell tower and hot spot as shown in FIG. 2

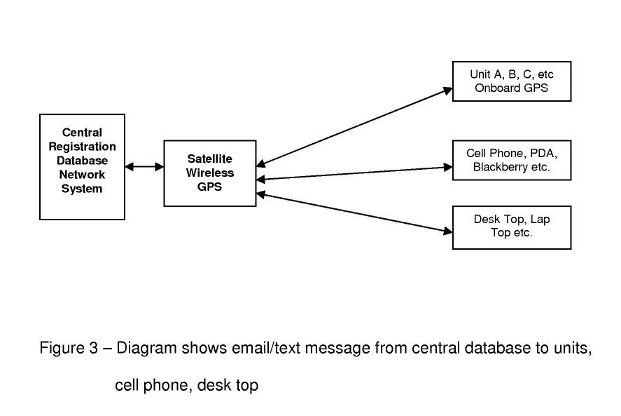

3. With ref. to claim 1, The diagram that shows email/text message method from central database to units, cell phone, desk top as shown in FIG. 3

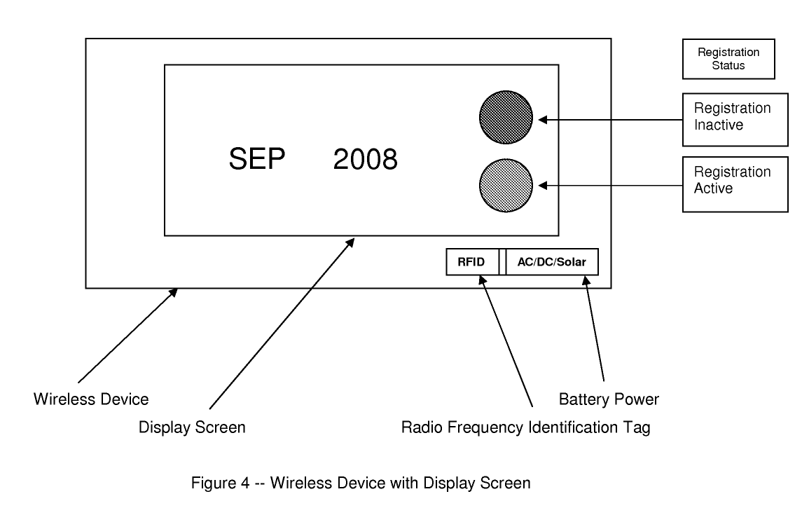

4. With ref. to claim 1, The wireless device with display screen and features as shown in FIG. 4

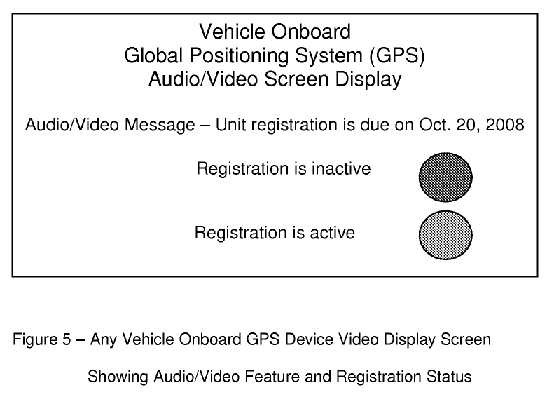

5. With ref. to claim 1, Any unit onboard GPS device video display screen showing audio/video feature and registration status as shown in FIG. 5

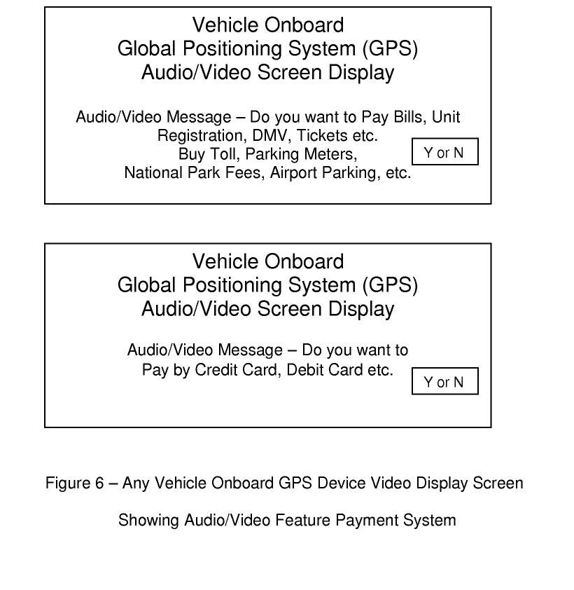

6. With ref. to claim 1, Any unit onboard GPS device video display screen showing audio/video feature payment system as shown in FIG. 6

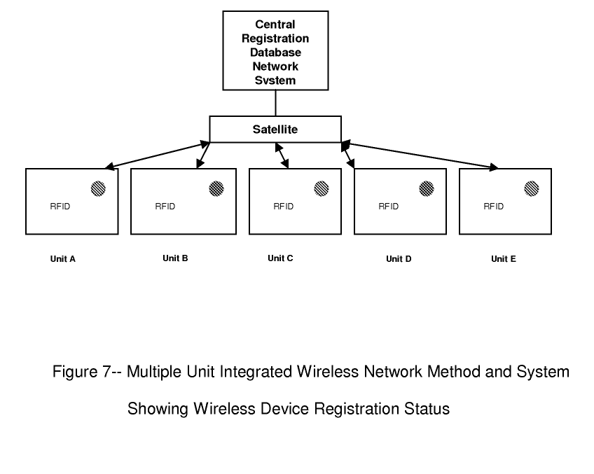

7. With ref. to claim 1, Multiple units integrated wireless network method and system showing wireless device registration status as shown in FIG. 7

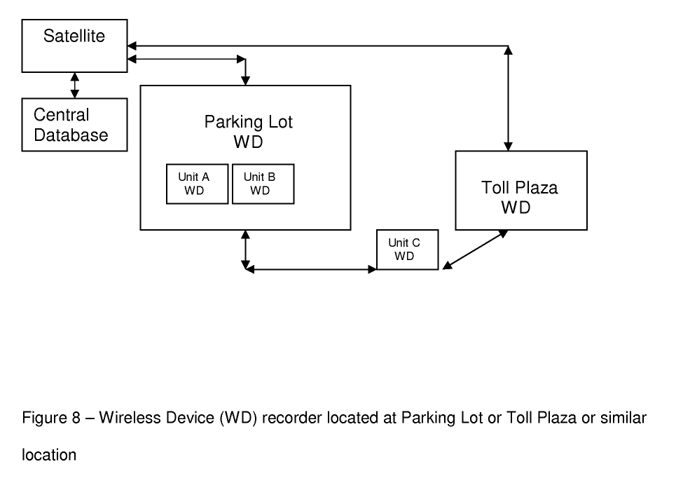

8. With ref. to claim 1, A wireless device recorder located at toll plaza or parking lots or any such location that tracks a unit entry into the particular zone in which it is and relays unit information from unit to central database as shown in FIG. 8

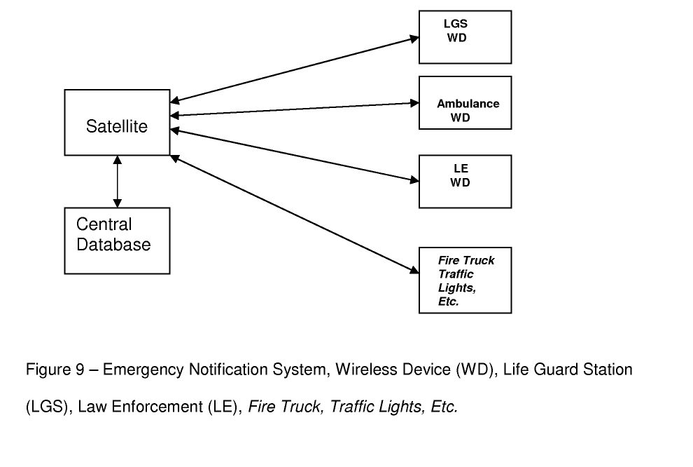

9. With ref. to claim 1, An Emergency Notification System that can be used by any unit/s as shown in FIG. 9, such as Life guard stations, ambulance, fire, law enforcement etc.

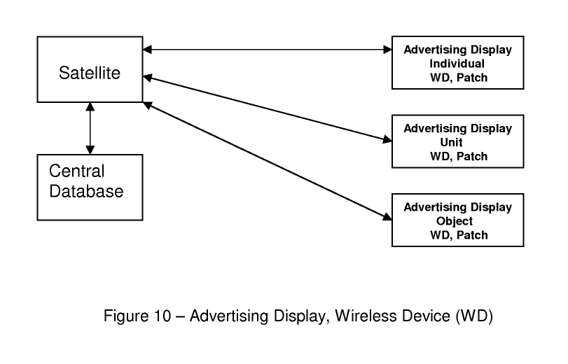

10. With ref. to claim 1, A wireless device such as a patch positioned on multiple individuals, objects or units that displays advertising as shown in FIG. 10
